(19) United States
(12) Patent Application Publication
(10) Pub. No.: US 2010/0121711 A1
(43) Pub. Date: May 13, 2010

(54) SYSTEM FOR ADVERTISING USING META-BLOG WEB PAGE AND PROFIT CREATING METHOD WITH IT

(75) Inventor: Yon-Ho Park, Seoul (KR)

Correspondence Address: LRK Patent Law Firm, 1952 Gallows Rd, Suite 200, Vienna, VA, 22182, US

(73) Assignee: NR SYSTEMS, INC., Seoul (KR)

(21) Appl. No.: 12/529,935

(22) PCT Filed: May 30, 2007
(86) PCT No.: PCT/KR07/02628

§ 371 Date: Jan. 6, 2010

(30) Foreign Application Priority Data
Mar. 5, 2007 (KR) 10-2007-0021682

(51) Int. Cl. G06Q 30/00; G06F 17/30

(52) U.S. Cl. 705/14.52; 707/802; 707/740; 705/14.49; 707/E17.044; 707/E17.089

(57) ABSTRACT

The present invention relates to an advertising system and profit creation method using a metablog web page, in which the personal website and the display target entity of a member are posted on a personal metablog web page, managed by a metablog server 200, when the member subscribes to the metablog server as a member while operating the personal website managed by a web server 100, and which provide some of advertising fees, incurred by posting the display target entity and paid by an advertiser client 300, to the member. Therefore, the present invention is advantageous in that, since all members, who operate personal websites through different web servers, use a metablog web page, new profit can be created in such a way that the members can be paid some of the advertising fees paid by an advertiser client.

### TECHNICAL FIELD

The present invention relates, in general, to an advertising system and profit creation method using a metablog web page, and, more particularly, to an advertising system and profit creation method using a metablog web page, in which the personal website and the display target entity of a member are posted on a personal metablog web page, managed by a metablog server, when the member subscribes to the metablog server as a member while operating the personal website managed by a web server, and which provide some of advertising fees, incurred by posting the display target entity and paid by an advertiser client, to the member.

### BACKGROUND ART

FIG. 1 is a diagram showing the construction of a conventional system for operating personal websites. The system includes a web server 10 and a plurality of personal websites 20 operated by the web server 10.

Through the system constructed as described above, the web server 10 provides personal websites to members who subscribe to the web server, and the members create their own online space by uploading pictures, text, characters, etc. to the provided personal websites.

As described above, the prior art is implemented such that only personal online space is created, and advertisements are not posted on personal websites, and thus, due thereto, members who operate personal websites do not receive separate benefits attributable to the posting of advertisements.

Furthermore, even in the case of a metablog site, in which respective personal websites operated by a plurality of web servers are gathered, advertisements are not posted, and thus, due thereto, members who operate personal websites, linked to the metablog site, do not receive any separate benefit attributable to the posting of advertisements.

### DISCLOSURE OF INVENTION

### Technical Problem

Accordingly, the present invention has been made keeping in mind the above problems occurring in the prior art, and an object of the present invention is to provide a system and method, in which both a personal website and a display target entity are posted on a personal metablog web page, managed by a metablog server, and which provide some of advertising fees, paid by an advertiser client who provides the display target entity, to the member who operates the personal website.

### Technical Solution

In accordance with an embodiment of the present invention to accomplish the above object, there is provided an advertising system using a metablog web page, comprising a plurality of different web servers, each managing a plurality of personal websites, a metablog server for allowing each of members who operate the plurality of personal websites to subscribe as a member, linking a personal website and a display target entity of the subscribed member to a personal metablog web page, and paying some of advertising fees, incurred when the display target entity is posted, to the member who subscribes to the metablog server, at least one advertiser client for providing the display target entity and the advertising fees to the metablog server; and a plurality of Internet user clients for accessing the metablog server, viewing the personal metablog web page, into which the personal web site and the display target entity are inserted, and clicking on the display target entity.

In accordance with another embodiment of the present invention to accomplish the above object, there is provided a profit creation method using a metablog web page, comprising the steps of a member, who operates a personal website managed by one of a plurality of different web servers, subscribing to a metablog server as a member by entering information required for member subscription, such as a URL of the personal website, into the metablog server, the metablog server receiving a display target entity and advertising fees from an advertiser client, the metablog server collecting text or images posted on the personal website using the URL, input at a time of member subscription, and generating analysis data obtained by analyzing features of the personal website, posting the analysis data on a main metablog web page through the metablog server so that Internet user clients click on the analysis data, if any one of a plurality of hypertext links provided in the main metablog web page is clicked by the Internet user clients, activating a personal metablog web page, and the metablog server linking both the personal web site and the display target entity to the activated personal metablog web page, the metablog server calculating a number of views on the personal metablog web page, to which the personal website and the display target entity are linked, by Internet user clients, or a number of clicks on the linked display target entity by Internet user clients, and the metablog server providing some of advertising fees, paid by the advertiser client, to the member who operates the personal website linked to the personal metablog web page, on a basis of calculation of measuring an advertisement provision contribution level.

### Advantageous Effects

According to the present invention, there is an advantage in that new profit can be created in such a way that all members, who operate personal websites through different web servers, use a metablog web page, and thus they can receive some of the advertising fees paid by an advertiser client.

### BRIEF DESCRIPTION OF THE DRAWINGS

FIG. 1 is a diagram showing the construction of a conventional system for operating personal websites;

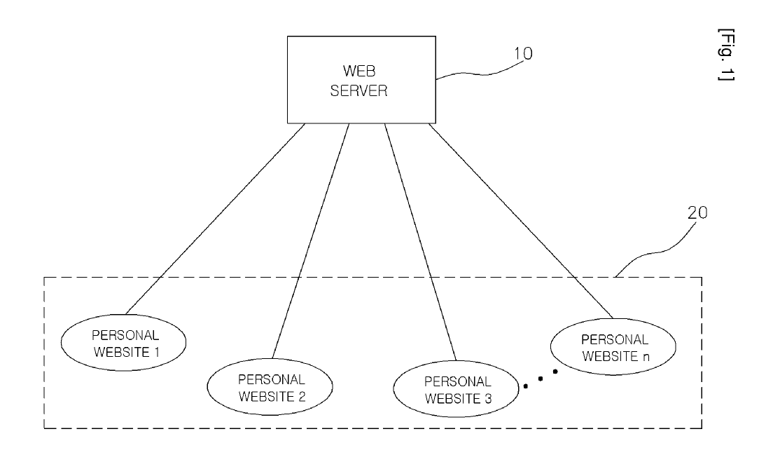

FIG. 2 is a diagram showing the construction of an advertising system using a metablog web page according to the present invention;

FIG. 3 is a diagram showing the construction of a metablog server according to the present invention;

FIG. 4 is a diagram showing an example of member subscription required for access to a metablog server according to the present invention;

FIG. 5 is a diagram showing the construction of a metablog operation application unit according to the present invention;

FIG. 6 is a diagram showing an example of a main metablog web page according to the present invention;

FIG. 7 is a diagram showing an example of a personal website according to the present invention;

FIG. 8 is a diagram showing an example of a personal metablog web page according to the present invention; and

FIG. 9 is a flowchart showing a profit creation method using a metablog web page according to the present invention.

### BEST MODE FOR CARRYING OUT THE INVENTION

Hereinafter, embodiments of the present invention will be described in detail with reference to the attached drawings.

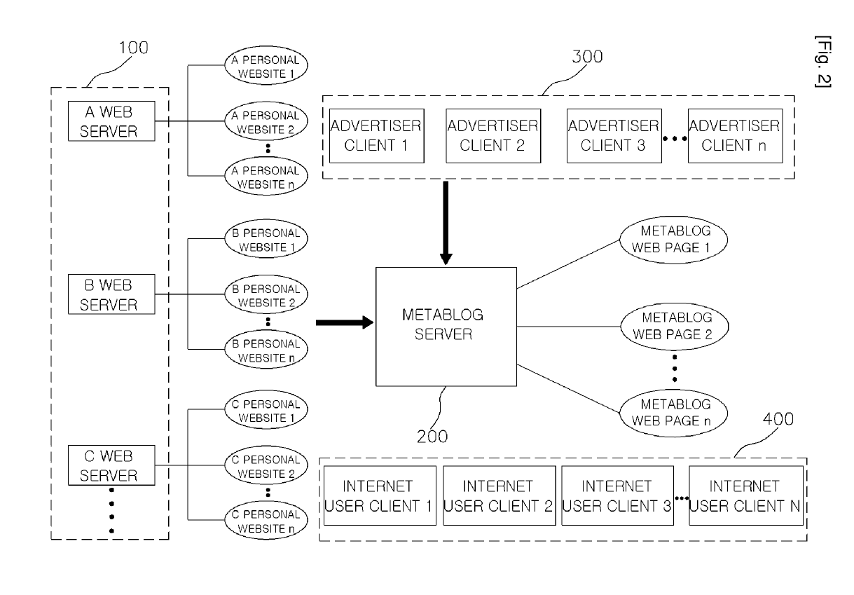

FIG. 2 is a diagram showing the construction of an advertising system using a metablog web page according to the present invention. The system includes a plurality of web servers 100, a metablog server 200, a plurality of advertiser clients 300, and a plurality of Internet user clients 400.

In detail, the plurality of web servers 100 is configured such that each of different web servers 100 manages a plurality of personal websites, and provides the personal websites to members who subscribe to a corresponding web server. The personal websites provided to the members are operated by the members themselves to create their own online space.

Preferably, the personal websites are blogs, cafes, etc., which are currently managed by a plurality of web servers.

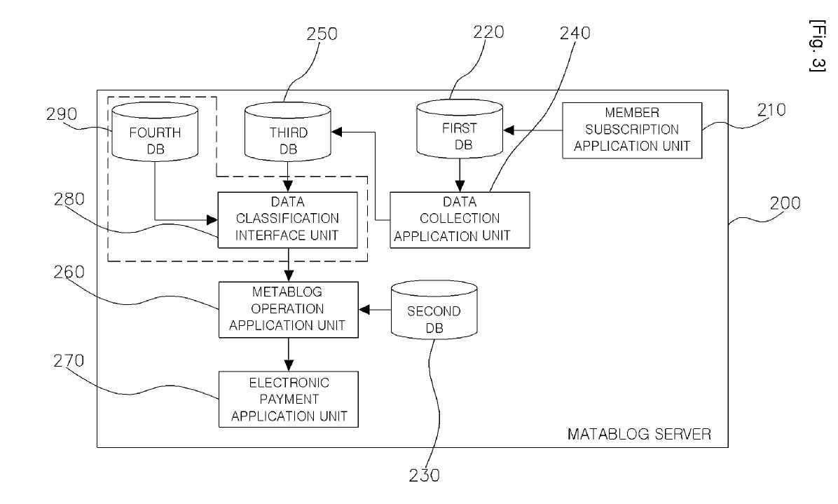

As shown in FIG. 3, the metablog server 200 includes a member subscription application unit 210 required for the use of the metablog server 200, a first Database (DB) 220 for storing member subscription data, a second DB 230 for storing display target entities and advertising fees, a data collection application unit 240 for collecting the features of personal websites, analyzing the collected features of the personal websites, and generating analysis data, a third DB 250 for storing the analysis data, a metablog operation application unit 260 for managing a main or personal metablog web page, and an electronic payment application unit 270. Further, preferably, the display target entities may be advertisements, news items, moving images, etc.

In addition to the member subscription application unit 210, the first DB 220, the second DB 230, the data collection application unit 240, the third DB 250, the metablog operation application unit 260 and the electronic payment application unit 270, the advertising system may further include a data classification application unit 280 for classifying the analysis data into respective categories, and a fourth DB 290 for storing words used for classification into categories.

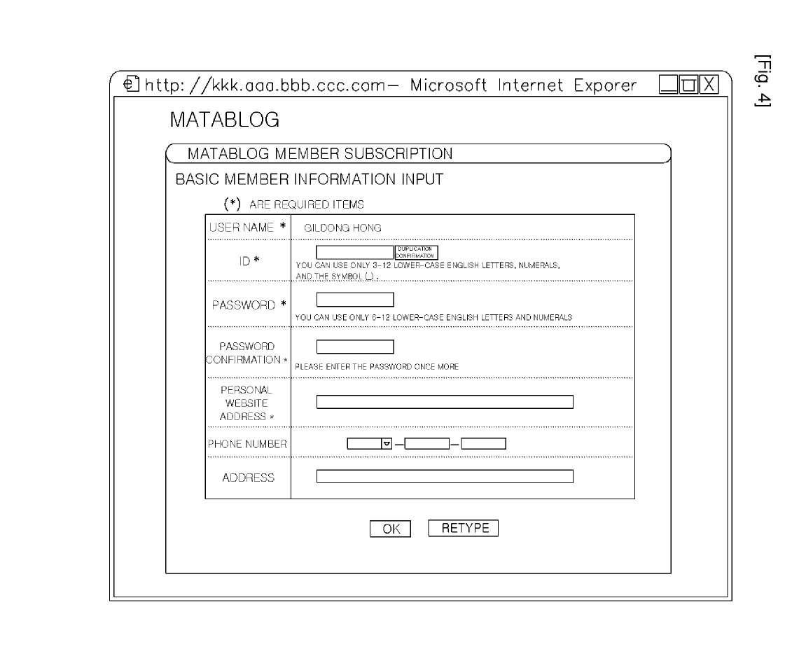

In detail, the member subscription application unit 210 of the metablog server 200 is configured to individually manage the plurality of personal websites using the plurality of different web servers 100, and allow the members who operate respective personal websites to subscribe to the metablog server 200 as members. As shown in FIG. 4, the metablog server 200 allows each of the members to personally record an ID, a password, the Uniform Resource Locator (URL) of a personal website, etc., thus allowing the member to be the member of the metablog server 200. The member personally records the ID, the password, the personal website URL, etc., and thus the metablog server 200 generates subscription data. The generated subscription data is transmitted to and stored in the first DB 220.

The first DB 220 of the metablog server 200 stores subscription data generated by the member subscription application unit 210, and separately stores only URLs included in the information of the subscription data.

The second DB 230 of the metablog server 200 stores display target entities, provided by the advertiser clients 300, and advertising fees so that the display target entities are linked to the personal metablog web page generated by the metablog server 200.

Further, preferably, the display target entities are stored according to category so that display target entities, suitable for personal websites classified into categories, are linked to the personal websites.

The data collection application unit 240 of the metablog server 200 extracts the

URLs stored in the first DB 220, posts the personal websites, operated by members, on the main metablog web page generated by the metablog server 200, using the extracted URLs, collects the features of the personal websites in real time to allow the Internet user clients 400 to select the personal websites, analyzes the collected features of the personal websites, and generates analysis data.

The analysis data is obtained by continuously collecting text, images, etc. recorded in the personal websites, so that the Internet user clients 400 can check the features of the personal websites, and the analysis data is transmitted to the third DB 250.

Further, the data collection application unit 220 transmits the extracted URLs to the third DB 250 while transmitting the analysis data to the third DB 250. The third DB 250 of the metablog server 200 stores the analysis data and the URLs, which are transmitted in real time through the data collection application unit 220, and thus the analysis data is updated and stored in real time.

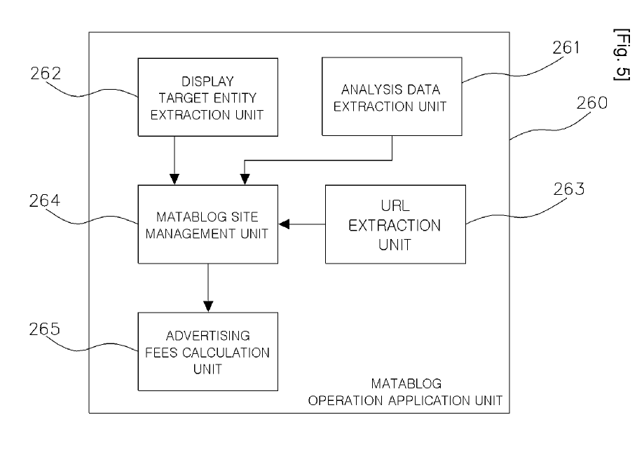

As shown in FIG. 5, the metablog operation application unit 260 of the metablog server 200 includes an analysis data extraction unit 261, a display target entity extraction unit 262, a URL extraction unit 263, a metablog site management unit 264, and an advertising fee calculation unit 265.

The analysis data extraction unit 261 of the metablog operation application unit 260 extracts analysis data stored in the third DB 250, and transmits the analysis data to the metablog site management unit 264.

In particular, when the data classification application unit 280 and the fourth DB 290 are further provided between the third DB 250 and the metablog operation application unit 260, the analysis data extraction unit 261 extracts the analysis data, which is classified by the data classification application unit 280 into respective categories, and transmits the analysis data to the metablog site management unit 264.

The display target entity extraction unit 262 of the metablog operation application unit 260 extracts a display target entity, stored in the second DB 230, and transmits the display target entity to the metablog site management unit 264.

In particular, when the data classification application unit 280 and the fourth DB 290 are further provided between the third DB 250 and the metablog operation application unit 260, the display target entity extraction unit 262 extracts analysis data, which is classified by the data classification application unit 280 into respective categories, and transmits the extracted analysis data to the metablog site management unit 264.

The URL extraction unit 263 of the metablog operation application unit 260 extracts a URL stored in the third DB 250, and transmits the URL to the metablog site management unit 264.

The metablog site management unit 264 of the metablog operation application unit 260 generates a main metablog web page 264-10 and a personal metablog web page 264-20 belonging to the main metablog web page.

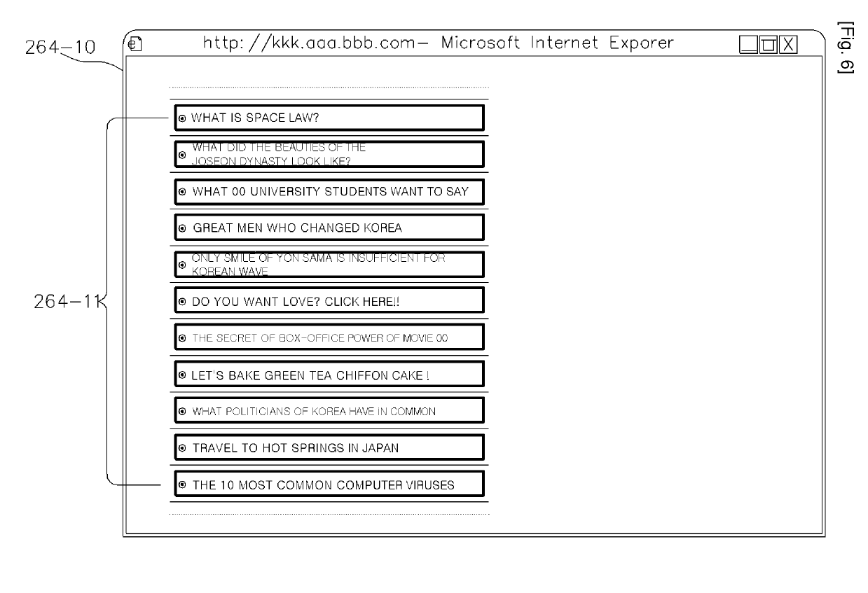

The generated main metablog web page 264-10 is implemented such that, as shown in FIG. 6, a plurality of hypertext links 264-11 is configured to be clicked by the Internet user clients to activate the personal metablog web page, and such that analysis data extracted by the analysis data extraction unit 261, that is, text, images, etc., is posted in the hypertext links 264-11, and a URL suitable for the posted analysis data is extracted by the URL extraction unit 263 and is linked to the analysis data.

Therefore, when each of the Internet user clients 400 selects any one from among the plurality of hypertext links 264-11, a personal metablog web page 264-20 corresponding to the selected one is activated.

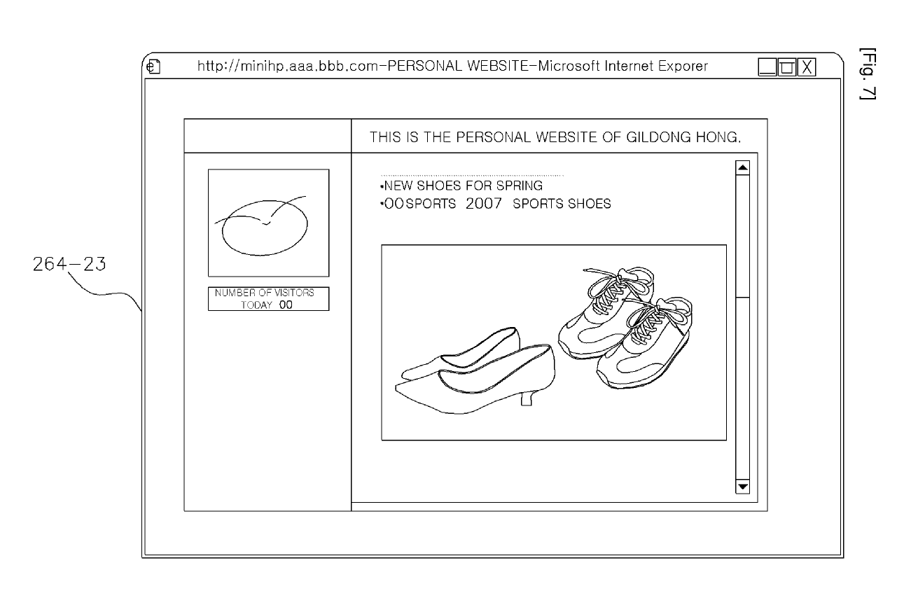

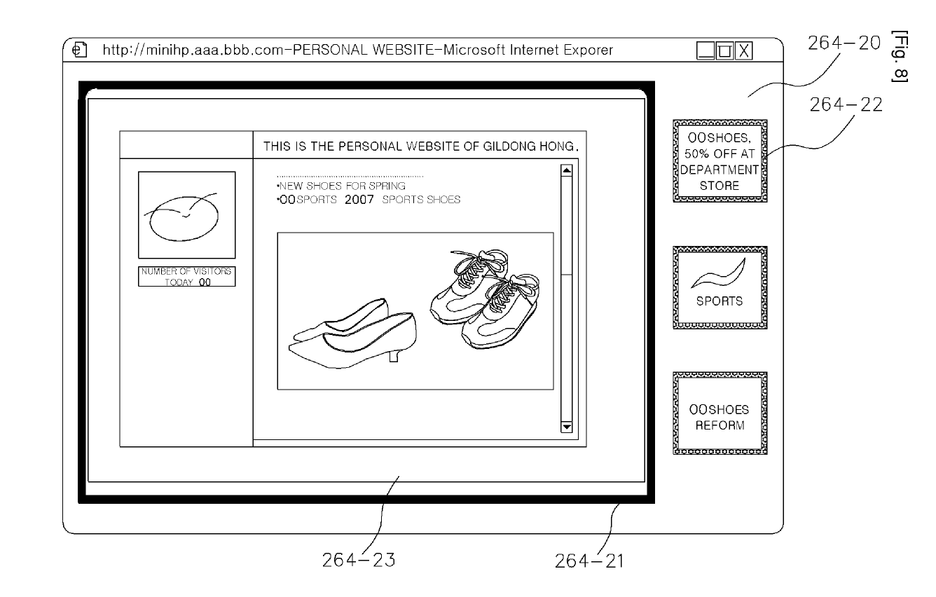

Further, the generated personal metablog web page 264-20 is implemented such that, as shown in FIG. 7, a display target entity is posted while a personal website is posted. That is, as shown in FIG. 8, the personal metablog web page is composed of a frame 264-21 in which a personal website is posted, and a frame 264-22 in which an advertisement is posted. The URL of a personal website is extracted by the URL extraction unit 263 and is linked to the frame 264-21 in which the personal website is posted, and thus the personal website is linked to the personal metablog web page. A display target entity is extracted by the display target entity extraction unit 262 and is linked to the frame 264-22 in which an advertisement is posted, and thus the display target entity is posted on the personal metablog web page.

In particular, when the data classification application unit 280 and the fourth DB 290 are further provided between the third DB 250 and the metablog operation application unit 260, it is also preferable that a display target entity suitable for analysis data be posted by the data classification application unit 280 in the frame 264-22 in which a display target entity is posted.

Therefore, in order to post display target entities suitable for personal websites classified into categories, it is preferable that display target entities be stored in the second DB 230 according to category.

The advertising fee calculation unit 265 of the metablog operation application unit 260 measures an advertisement provision contribution level based on the number of views on the display target entity, posted on the personal metablog web page 264-20 generated by the metablog site management unit 264, or the number of clicks on the display target entity posted on the personal metablog web page 264-20, and calculates required advertising fees so that some of the advertising fees paid by an advertiser is paid to the member who operates the personal website, on the basis of the advertisement provision contribution level.

The electronic payment application unit 270 of the metablog server 200 pays the advertising fees calculated by the advertising fee calculation unit 265 of the metablog operation application unit 260 to the member who posts the personal website on the personal metablog web page.

The advertiser clients 300 provide the display target entities and advertising fees to the metablog server 200.

In particular, when the advertiser client 300 selects a desired category, a display target entity is displayed in a personal metablog web page corresponding to the category desired by the advertiser client 300.

In the procedure in which the metablog operation application unit 260 extracts analysis data stored in the third DB 250, the data classification application unit 280 of the metablog server 200 compares words, stored according to category in the fourth DB 290, with the text-format words of the analysis data, stored in the third DB 250, classifies the analysis data into corresponding categories, and transmits the classified analysis data to the metablog operation application unit 260.

For example, since the personal website of FIG. 7 is a personal website related to footwear, a large number of words related to footwear, such as “shoes,” “sports shoes,” “sandals,” “boots,” “sports,” “formal dress,” “men's shoes,” and “inline skates,” are displayed when text content is analyzed, and are compared to words stored according to category in the fourth DB 290 that includes the above words, and thus the above words are determined to belong to “footwear” among the necessities of life.

In this case, the analysis of the text of the personal website and the words stored according to category in the fourth DB 290 may be performed by analyzing one or more categories. That is, of the above words, words “sports shoes,” “sports,” and “inline skates” are related to sports, and thus they can be analyzed as supplies for leisure falling in the category of “sports.”

Therefore, since words are analyzed as one or more categories, display target entities corresponding to one or more analyzed categories are displayed in the metablog page on which the personal website is posted.

The fourth DB 290 of the metablog server 200 stores in advance related words according to category, such as society, economics, politics, and culture, and also stores words corresponding to detailed fields belonging to each of the categories. That is, words used to classify the analysis data, stored in the third DB 250, into respective categories are stored in advance according to category.

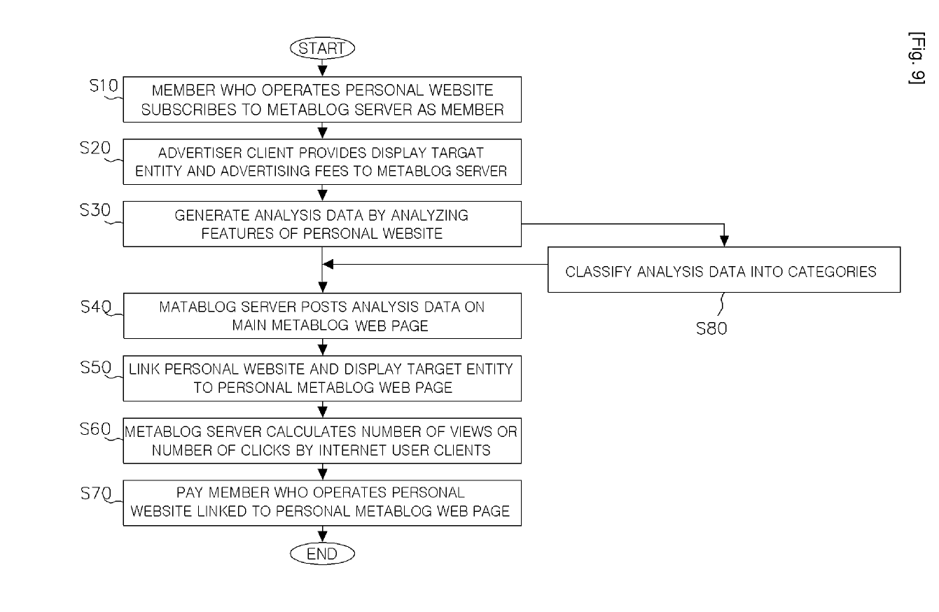

FIG. 9 is a flowchart showing a profit creation method using a metablog web page according to the present invention. The profit creation method includes the following steps.

The method includes the step S10 of a member, who operates a personal website managed by one of a plurality of different web servers, subscribing to the metablog server as a member by entering information required for member subscription, such as the URL of the personal website, into the metablog server, the step S20 of the metablog server receiving a display target entity and advertising fees from an advertiser client, the step S30 of the metablog server collecting text, images, etc., posted on the personal website, using the URL input at the time of member subscription, and generating analysis data obtained by analyzing the features of the personal website, the step S40 of posting the analysis data on a main metablog web page through the use of the metablog server so that an Internet user client can click on the analysis data, the step S50 of, when any one of a plurality of hypertext links provided in the main metablog web page is clicked by the Internet user client, activating a personal metablog web page, and the metablog server linking both the personal website and the display target entity to the activated personal metablog web page, the step S60 of the metablog server calculating the number of views on the personal metablog web page, to which the personal website and the display target entity are linked, by Internet user clients, or the number of clicks on the linked display target entity by Internet user clients, and the step S70 of the metablog server providing some of the advertising fees paid by the advertiser client to the member who operates the personal website linked to the personal metablog web page, on the basis of calculation of measuring an advertisement provision contribution level.

In addition, the method may further include, between steps S30 and S40, the step S80 of comparing important words of the text of the analysis data with words prestored according to category, classifying the analysis data into respective categories, and extracting the classified analysis data.

In more detail, the step S10 of a member, who operates a personal website managed by one of a plurality of different web servers, subscribing to the metablog server as a member by entering information required for member subscription, such as the URL of the personal website, into the metablog server is performed such that an arbitrary member subscribes to the web server that manages the personal website as a member in order to operate his or her personal website, thus operating the personal website.

The web servers 100, which manage personal websites, are plural in number, and the personal websites, operated by respective members who individually subscribe to the plurality of web servers 100 as members, are also plural in number, so that a plurality of members, who operate respective personal websites using the plurality of different web servers 100, subscribes to the metablog server 200, which collects personal websites and manages the personal websites in an integrated manner, as members through the member subscription application unit 210 of the metablog server 200.

The step S20 of the metablog server receiving a display target entity and advertising fees from an advertiser client is performed such that, in a personal metablog web page 264-20 composed of a frame 264-21 in which a personal website is posted, and a frame 264-22 in which a display target entity is posted, the metablog server 200 receives the display target entity from the advertiser client 300 to allow the display target entity to be posted in the display target entity posting frame 264-22, and such that the metablog server 200 receives advertising fees, incurred when the display target entity is posted on the personal metablog web page 264-20, from the advertiser client 300.

The step S30 of the metablog server collecting text, images, etc., posted on the personal website, using the URL input at the time of member subscription, and generating analysis data obtained by analyzing the features of the personal website is performed such that, in order to analyze the features of the personal website operated by each member using the URL input at the time of member subscription, the data collection application unit 240 of the metablog server 200 continuously collects text, images, etc., recorded in the personal website, generates the analysis data, and stores both the analysis data and the URL.

The step S40 of posting the analysis data on a main metablog web page through the use of the metablog server so that an Internet user client can click on the analysis data is performed such that the metablog site management unit 264 generates the main metablog web page 264-10 and the personal metablog web page 264-20 belonging to the main metablog web page, and a plurality of hypertext links, required in order to post the analysis data extracted by the analysis data extraction unit 261 on the generated main metablog web page 264-10, is configured. The analysis data extracted by the analysis data extraction unit 261 is posted on the configured hypertext links, thus allowing the Internet user client 400 to click on the posted frame.

The step S50 of, when any one of a plurality of hypertext links provided in the main metablog web page is clicked by the Internet user client, activating a personal metablog web page, and the metablog server linking both the personal website and the display target entity to the activated personal metablog web page, is performed such that, when the Internet user client 400 clicks on any one of the plurality of hypertext links configured in the main metablog web page 264-10, the personal metablog web page 264-20 is activated.

The activated personal metablog web page 264-20 is composed of the personal website posting frame 264-21 and the display target entity posting frame 264-22. The URL of the personal website to be posted is extracted by the URL extraction unit 263 and is linked to the personal website posting frame 264-21, and thus the personal website is posted. The display target entity to be posted is extracted by the display target entity extraction unit 262 and is linked to the display target entity posting frame 264-22, and thus the display target entity is posted.

The step S60 of the metablog server calculating the number of views on the personal metablog web page, to which the personal website and the display target entity are linked, by Internet user clients, or calculating the number of clicks on the linked display target entity by Internet user clients, is performed such that the advertising fee calculation unit 265 of the metablog operation application unit 260 measures an advertisement provision contribution level based on the number of views on or the number of clicks on the display target entity, and calculates required advertising fees so that some of the advertising fees paid by the advertiser is paid to the member who operates the personal website, on the basis of the advertisement provision contribution level.

The step S70 of the metablog server providing some of advertising fees, paid by the advertiser client, to the member who operates the personal website linked to the personal metablog web page, on the basis of calculation of measuring the advertisement provision contribution level is performed such that the electronic payment application unit 270 of the metablog server 200 pays advertising fees calculated by the advertising fee calculation unit 265 of the metablog operation application unit 260 to the member who posts the personal website on the personal metablog web page.

In particular, when the advertiser client 300 selects a desired category, the display target entity is displayed in a personal metablog web page corresponding to the category desired by the advertiser client 300.

The step S80 of comparing important words of the text of the analysis data with words prestored according to category, classifying the analysis data into respective categories, and extracting the classified analysis data is performed such that words stored according to category in the fourth DB 290 are compared to text-format words of the analysis data stored in the third DB 250, and the analysis data is classified into corresponding categories, and thus the analysis data classified into respective categories is transmitted during the process for extracting the classified analysis data.

Although the preferred embodiments of the present invention have been disclosed for illustrative purposes, it should be noted that the embodiments are only examples and are not intended to limit the present invention. Any and all modifications and variations of components or equivalent arrangements which may occur to those skilled in the art should be considered to belong within the scope of the invention, rather than departing from the spirit or fields of the invention as disclosed in the accompanying claims.

1. An advertising system using a metablog web page, comprising:
a plurality of different web servers, each managing a plurality of personal websites;
a metablog server for allowing each of members who operate the plurality of personal websites to subscribe as a member, linking a personal website and a display target entity of the subscribed member to a personal metablog web page, and paying some of advertising fees, incurred when the display target entity is posted, to the member who subscribes to the metablog server;
at least one advertiser client for providing the display target entity and the advertising fees to the metablog server; and
a plurality of Internet user clients for accessing the metablog server, viewing the personal metablog web page, into which the personal web site and the display target entity are inserted, and clicking on the display target entity.

2. The advertising system according to claim 1, wherein the metablog server comprises:
a member subscription application unit for individually managing the plurality of personal websites using the plurality of different web servers, allowing each of the members who operate respective personal websites to subscribe as a member, and generating subscription data based on the member subscription;
a first Database (DB) for storing the subscription data and separately storing only Uniform Resource Locators (URLs) included in information of the subscription data;
a second DB for storing the display target entity and the advertising fees, provided by the advertiser client;
a data collection application unit for collecting features of the personal websites in real time using the URLs stored in the first DB, analyzing the collected features of the personal websites, and generating analysis data;
a third DB for updating and storing the analysis data and the URLs in real time;
a metablog operation application unit for generating a main metablog web page to which the analysis data and the URLs, stored in the third DB, are linked, and a personal metablog web page on which the personal website and the display target entity are posted, and calculating a number of views on the personal metablog web page by the Internet user clients, or a number of clicks on the display target entity by the Internet user clients; and
an electronic payment application unit for paying some of advertising fees paid by the advertiser client to the member, who operates the personal website posted on the personal metablog web page, on a basis of the calculation.

3. The advertising system according to claim 2, further comprising:
a fourth DB for storing words corresponding to each category to classify the analysis data, stored in the third DB, into categories; and
a data classification application unit for comparing the words stored in the fourth DB with text-format words of the analysis data stored in the third DB, and classifying the analysis data into corresponding categories.

4. The advertising system according to claim 1 or 2, wherein the display target entity is an advertisement, a news item or a moving image.

5. The advertising system according to claim 2, wherein the metablog operation application unit comprises:
an analysis data extraction unit for extracting analysis data stored in the third DB;
a display target entity extraction unit for extracting a display target entity stored in the second DB;
a URL extraction unit for extracting a URL stored in the third DB;
a metablog site management unit for generating the main metablog web page, in which a plurality of hypertext links to be clicked by the Internet user clients is configured to activate the personal metablog web page, the analysis data extracted by the analysis data extraction unit is linked to the plurality of hypertext links, and a URL suitable for the linked analysis data is extracted by the URL extraction unit and is linked to the analysis data, and generating the personal metablog web page, which includes a frame, in which the personal website is posted, and a frame, in which the display target entity is posted, and which is configured such that a URL of a personal website is extracted by the URL extraction unit and is linked to the frame, in which the personal website is posted, and a display target entity is extracted by the display target entity extraction unit and is linked to the frame, in which the display target entity is posted; and
an advertising fee calculation unit for measuring an advertisement provision contribution level based on a number of views or clicks on the display target entity posted on the personal metablog web page.

6. The advertising system according to claim 2, wherein the second DB stores the display target entities according to category.

7. The advertising system according to claim 5, wherein the analysis data extraction unit extracts analysis data classified into respective categories by the data classification application unit and transmits the analysis data to the metablog site management unit when the data classification application unit and the fourth DB are further provided between the third DB and the metablog operation application unit.

8. The advertising system according to claim 7, wherein the analysis data is analyzed as one or more categories, and display target entities corresponding to one or more analyzed categories are posted on the personal metablog web page.

9. The advertising system according to claim 5, wherein the personal metablog web page is implemented such that display target entities corresponding to a category similar to a category of the personal website are posted.

10. A profit creation method using a metablog web page, comprising the steps of:
a member, who operates a personal website managed by one of a plurality of different web servers, subscribing to a metablog server as a member by entering information required for member subscription, such as a URL of the personal website, into the metablog server;
the metablog server receiving a display target entity and advertising fees from an advertiser client;
the metablog server collecting text or images posted on the personal website using the URL, input at a time of member subscription, and generating analysis data obtained by analyzing features of the personal website;
posting the analysis data on a main metablog web page through the metablog server so that Internet user clients click on the analysis data;
if any one of a plurality of hypertext links provided in the main metablog web page is clicked by the Internet user clients, activating a personal metablog web page, and the metablog server linking both the personal web site and the display target entity to the activated personal metablog web page;
the metablog server calculating a number of views on the personal metablog web page, to which the personal website and the display target entity are linked, by Internet user clients, or a number of clicks on the linked display target entity by Internet user clients; and
the metablog server providing some of advertising fees, paid by the advertiser client, to the member who operates the personal website linked to the personal metablog web page, on a basis of calculation of measuring an advertisement provision contribution level.

11. The profit creation method according to claim 10, further comprising, between the step of generating the analysis data and the step of posting on the main metablog web page, the step of comparing important words of text of the analysis data with words prestored according to category, classifying the analysis data into respective categories, and extracting classified analysis data.

12. The profit creation method according to claim 10, wherein the step of providing some of advertising fees to the member who operates the personal website linked to the personal metablog web page is performed to measure the advertisement provision contribution level based on the number of views on or the number of clicks on the personal metablog web page, and to pay some of the paid advertising fees to the member who operates the personal website on a basis of the advertisement provision contribution level.

13. The profit creation method according to claim 12, wherein the display target entity is an advertisement, a news item or a moving image.

14. The profit creation method according to claim 12, wherein the analysis data is analyzed as one or more categories, and display target entities corresponding to one or more analyzed categories are posted on the personal metablog web page.

15. The profit creation method according to claim 10, wherein the personal metablog web page is implemented such that display target entities corresponding to a category similar to a category of the personal website are posted.
